(19) United States
(12) Patent Application Publication
(10) Pub. No.: US 2026/0043116 A1
(43) Pub. Date: Feb. 12, 2026

(54) CEMENTED CARBIDE AND CUTTING TOOL

(71) Applicant: Sumitomo Electric Hardmetal Corp., Itami-shi, Hyogo (JP)

(72) Inventors: Yasuki KIDO, Itami-shi, Hyogo (JP); Takahiro SEKIYA, Itami-shi, Hyogo (JP)

(73) Assignee: Sumitomo Electric Hardmetal Corp., Itami-shi, Hyogo (JP)

(21) Appl. No.: 19/123,782

(22) PCT Filed: Aug. 8, 2024
(86) PCT No.: PCT/JP2024/028454

§ 371 Date: Apr. 24, 2025

(51) Int. Cl. C22C 29/02; B22F 3/16; B22F 3/24; B23B 27/14; C22C 1/051; C22C 29/00

(52) U.S. Cl. CPC C22C 29/02; B22F 3/16; B22F 3/24; B23B 27/148; C22C 1/051; C22C 29/005; B22F 2003/248; B22F 2301/15; B22F 2301/20; B22F 2301/25; B22F 2301/30; B22F 2302/10; B22F 2304/10; B22F 2998/10; B22F 2999/00; B23B 2224/32

(57) ABSTRACT

A cemented carbide including tungsten carbide particles and a binder phase, in which the cemented carbide includes 89 vol % to 100 vol % of the tungsten carbide particles and the binder phase in total, the cemented carbide includes 0.5 vol % to 25 vol % of the binder phase; the binder phase includes 40 mass % or more of cobalt, the binder phase further includes at least one first element selected from the group consisting of silicon, phosphorus, germanium, tin, rhenium, ruthenium, osmium, iridium, and platinum, and a frequency of inconsistency in atomic arrangements of cobalt atoms in a rectangular measurement region provided in a TEM-HAADF image obtained by observing a (110) plane of the cobalt having an fcc structure using an atomic resolution transmission electron microscope, in which the rectangular measurement region contains 31 cobalt atoms in a first direction and 5 to 10 cobalt atoms in a second direction, is 8% or more and 30.0% or less.

### TECHNICAL FIELD

The present disclosure relates to a cemented carbide and a cutting tool.

### BACKGROUND ART

Conventionally, cemented carbides comprising a plurality of tungsten carbide particles and a binder phase have been used as a material for cutting tools (PTL 1).

### CITATION LIST

### Patent Literature

PTL 1: Japanese Patent Laying-Open No. 2004-131769

### SUMMARY OF INVENTION

The cemented carbide of the present disclosure is a cemented carbide comprising a plurality of tungsten carbide particles and a binder phase, wherein the cemented carbide comprises 89% by volume or more and 100% by volume or less of the tungsten carbide particles and the binder phase in total, the cemented carbide comprises 0.5% by volume or more and 25% by volume or less of the binder phase, the binder phase comprises 40% by mass or more of cobalt, the binder phase further comprises at least one first element selected from the group consisting of silicon, phosphorus, germanium, tin, rhenium, ruthenium, osmium, iridium, and platinum, and a frequency of inconsistency in atomic arrangements of cobalt atoms in a rectangular measurement region provided in a TEM-HAADF image obtained by observing a (110) plane of the cobalt having an fcc structure at a magnification of'S million times using an atomic resolution transmission electron microscope, in which the rectangular measurement region contains 31 cobalt atoms in a first direction and 5 or more and 10 or less cobalt atoms in a second direction orthogonal to the first direction, is 8% or more and 30.0% or less.

### BRIEF DESCRIPTION OF DRAWINGS

FIG. 1 is an example of an IPF map of the cemented carbide of Embodiment 1.

FIG. 2 is an example of a TEM-HAADF image of the cemented carbide of Embodiment 1.

FIG. 3 is an example showing extraction of the measurement region set in the TEM HAADF image of FIG. 2.

FIG. 4 is a schematic diagram of the cutting tool of Embodiment 2.

### DETAILED DESCRIPTION

### Problem to be Solved by the Present Disclosure

In recent years, technology has been developed to improve the heat resistance of printed circuit boards in order to accommodate a high capacity of information. On the other hand, this is making printed circuit boards more difficult to cut. For this reason, there is a tendency for cutting tools to fracture in the processing of printed circuit boards.

Accordingly, an object of the present disclosure is to provide a cemented carbide capable of extending the life of a cutting tool, especially even when used as a material of a cutting tool for drilling a printed circuit board, and a cutting tool comprising the cemented carbide.

### Advantageous Effect of the Present Disclosure

According to the present disclosure, a cemented carbide capable of extending the life of a cutting tool, especially even when used as a material of a cutting tool for drilling a printed circuit board, and a cutting tool comprising the cemented carbide can be provided.

### DESCRIPTION OF EMBODIMENTS

Initially, embodiments of the present disclosure will be listed and described.
(1) The cemented carbide of the present disclosure is a cemented carbide comprising a plurality of tungsten carbide particles and a binder phase, wherein the cemented carbide comprises 89% by volume or more and 100% by volume or less of the tungsten carbide particles and the binder phase in total, the cemented carbide comprises 0.5% by volume or more and 25% by volume or less of the binder phase, the binder phase comprises 40% by mass or more of cobalt, the binder phase further comprises at least one first element selected from the group consisting of silicon, phosphorus, germanium, tin, rhenium, ruthenium, osmium, iridium, and platinum, and a frequency of inconsistency in atomic arrangements of cobalt atoms in a rectangular measurement region provided in a TEM HAADF image obtained by observing a (110) plane of the cobalt having an fee structure at a magnification of 5 million times using an atomic resolution transmission electron microscope, in which the rectangular measurement region contains 31 cobalt atoms in a first direction and 5 or more and 10 or less cobalt atoms in a second direction orthogonal to the first direction, is 8% or more and 30.0% or less.

According to the present disclosure, a cemented carbide capable of extending the life of a cutting tool, especially even when used as a material of a cutting tool for drilling a printed circuit board, can be provided. The reason for this is inferred as follows.

The cemented carbide of the present disclosure comprises a plurality of tungsten carbide particles (hereinafter also referred to as “WC particles”) and a binder phase. The total content of the WC particles and the binder phase in the cemented carbide is 89% by volume or more and 100% by volume or less. According to this, the cemented carbide has high hardness and strength, and the cutting tool comprising the cemented carbide can have excellent wear resistance and fracture resistance.

The cemented carbide of the present disclosure comprises 0.5% by volume or more and 25% by volume or less of the binder phase. The binder phase comprises 40% by mass or more of cobalt. When the content of the binder phase in the cemented carbide is 0.5% by volume or more, the toughness of the cemented carbide is improved. When the content of the binder phase in the cemented carbide is 25% by volume or less, the hardness of the cemented carbide is improved. Accordingly, the cutting tool comprising the cemented carbide can have excellent wear resistance and fracture resistance.

In the cemented carbide of the present disclosure, the binder phase further comprises at least one first element selected from the group consisting of silicon, phosphorus, germanium, tin, rhenium, ruthenium, osmium, iridium, and platinum, According to this, the strength of the binder phase itself, the interfacial strength between the tungsten carbide particles to each other, and the interfacial strength between the tungsten carbide particles and the binder phase are improved in the cemented carbide. Accordingly, in a cutting tool comprising the cemented carbide, the wear of the binder phase and the shedding of the tungsten carbide particles are suppressed during cutting processing, and the cutting tool can have a long tool life.

In the cemented carbide of the present disclosure, a frequency of inconsistency in atomic arrangements of cobalt atoms in a rectangular measurement region provided in a TEM-HAADF image obtained by observing a (110) plane of the cobalt having an fcc structure at a magnification of 5 million times using an atomic resolution transmission electron microscope, in which the rectangular measurement region contains 31 cobalt atoms in a first direction and S or more and 10 or less cobalt atoms 16 in a second direction orthogonal to the first direction, is 8% or more and 30.0% or less. When the frequency of inconsistency in atomic arrangements of cobalt atoms is 8% or more, the dislocation progression in the portions where the atomic arrangements of the cobalt atoms are inconsistent is easy to be inhibited, and the toughness and fatigue strength of the cemented carbide are improved. When the frequency of inconsistency in atomic arrangements of cobalt atoms is 30% or less, the strength of the cemented carbide can be maintained. Accordingly, a cutting tool comprising the cemented carbide has an improved fatigue fracture resistance during cutting processing while maintaining the strength, and the tool life is improved. Here, the fatigue fracture is a fracture that occurs after a certain amount of processing time has elapsed after the cutting tool has started to be used.
(2) In the above (1), the frequency of inconsistency in atomic arrangements of the cobalt atoms may be 10% or more. According to this, a cutting tool comprising the cemented carbide has a further improved fatigue fracture resistance during cutting processing, and the tool life is further improved.
(3) In the above (1) or (2), in the binder phase, a percentage {M1/(M1+M2)}×100 of a mass M1 of the first element with respect to a total M1+M2 of mass M1 of the first element and a mass M2 of the cobalt may be 0.2% or more and 25% or less. Here, the units of mass M1 and mass M2 are the same. When {M1/(M1+M2)}×100 is 0.2% or more, the strength of the binder phase itself, the interfacial strength between the tungsten carbide particles to each other, and the interfacial strength between the tungsten carbide particles and the binder phase in the cemented carbide are further improved Accordingly, in a cutting tool comprising the cemented carbide, the wear of the binder phase and the shedding of the tungsten carbide particles are further suppressed during the cutting processing, and the tool life of the cutting tool is further improved. When (M1/(M1+M2))×100 is 25% or less, the strength of the cemented carbide is improved.
(4) In any of the above (1) to (3), the average particle size of the tungsten carbide particles may be 0.2 μm or more and 3 μm or less. When the average particle size of the WC particles is 0.2 μm or more, the hardness and strength of the cemented carbide are improved. When the average particle size of the WC particles is 3 am or less, the hardness of the cemented carbide is improved. Accordingly, the wear resistance of a cutting tool comprising the cemented carbide is improved, and the tool life thereof is improved.
(5) In any of the above (1) to (4), the frequency of inconsistency in atomic arrangements of the cobalt atoms is a percentage of the number of boundaries between the atomic arrangements in which adjacent atomic arrangements of the cobalt atoms are inconsistent, with respect to the total number of boundaries between the atomic arrangements of the cobalt atoms in the measurement region. The boundary between the atomic arrangements of the cobalt atoms in the measurement region is a boundary extending in a direction along the second direction.
(6) The cutting tool of the present disclosure is a cutting tool comprising a cutting edge consisting of the cemented carbide according to any of the above (1) to (5).

According to this, a cutting tool having a long tool life can be provided, especially when used for drilling a printed circuit board.

### DETAILS OF EMBODIMENTS OF THE PRESENT DISCLOSURE

Specific examples of the cemented carbide and cutting tool of the present disclosure will be described with reference to the drawings below. In the drawings of the present disclosure, the same reference numerals represent the same portion or a corresponding portion. The dimensional relationships such as length, width, thickness, and depth are appropriately changed for the clarity and simplification of the drawings, and do not necessarily represent the actual dimensional relationships.

In the present disclosure, the notation in the form “A to B” means A or more and B or less, and when no unit is described in A and only described in B, the unit of A and the unit of B are the same.

In the present disclosure, when a compound or the like is represented by a chemical formula, it is assumed that all conventionally known atomic ratios are included unless the atomic ratio is particularly limited, and should not necessarily be limited to only those in the stoichiometric range.

In the present disclosure, when one or more numerical values are described as each of the lower limit and the upper limit of a numerical range, combinations of any one numerical value described as the lower limit and any one numerical value described as the upper limit are also to be disclosed.

In the present disclosure, the terms “comprising”, “including”, “having”, and variations thereof are open-ended terms. The open-ended terms may or may not include an additional element in addition to the essential elements. The term “consisting of” is a closed term. However, even the configurations expressed with the closed term may include an additional element that is a normally accompanying impurity or is irrelevant to the subject art.

### Embodiment 1: Cemented Carbide

The cemented carbide of one embodiment of the present disclosure (hereinafter also referred to as “Embodiment I”) is a cemented carbide comprising a plurality of tungsten carbide particles and a binder phase, wherein the cemented carbide comprises 89% by volume or more and 100% by volume or less of the tungsten carbide particles and the binder phase in total, the cemented carbide comprises 0.5% by volume or more and 25% by volume or less of the binder phase, the binder phase comprises 40% by mass or more of cobalt, the binder phase further comprises at least one first element selected from the group consisting of silicon, phosphorus, germanium, tin, rhenium, ruthenium, osmium, iridium, and platinum, and a frequency of inconsistency in atomic arrangements of cobalt atoms in a rectangular measurement region provided in a TEM-HAADF image obtained by observing a (110) plane of the cobalt having an fee structure at a magnification of 5 million times using an atomic resolution transmission electron microscope, in which the rectangular measurement region contains 31 cobalt atoms in a first direction and S or more and 10 or less cobalt atoms in a second direction orthogonal to the first direction, is 8% or more and 30.0% or less.

### <Composition of Cemented Carbide>

The cemented carbide of Embodiment I comprises 89% by volume or more and 100% by volume or less of the tungsten carbide particles and the binder phase in total. The cemented carbide may comprise 90% by volume or more and 100% by volume or less, or 92% by volume or more and 100% by volume or less of the tungsten carbide particles and the binder phase in total.

The cemented carbide of Embodiment 1 comprises 0.5% by volume or more and 25% by volume or less of the binder phase. The content of the binder phase in the cemented carbide may be 1% by volume or more and 20% by volume or less, 1% by volume or more and 15% by volume or less, or 1% by volume or more and 13% by volume or less.

The cemented carbide of Embodiment I may consist of a plurality of tungsten carbide particles and a binder phase. To the extent that the effect of the present disclosure is not impaired, the cemented carbide of Embodiment 1 may consist of a plurality of tungsten carbide particles, a binder phase, and an impurity.

The cemented carbide may comprise another phase (not shown) in addition to the tungsten carbide particles and the binder phase. Examples of the another phase include carbides, nitrides or carbonitrides comprising at least one element selected from the group consisting of titanium (Ti), tantalum (Ta), niobium (Nb), zirconium (Zr), hafnium (Hf) and molybdenum (Mo). The composition of the another phase may be, for example, at least one selected from the group consisting of TiCN, TaC, NbC, ZrC, HfC, and Mo₂C.

The content of the another phase in the cemented carbide is acceptable to the extent that the effect of the present disclosure is not impaired. The content of the another phase in the cemented carbide may be more than 0% by volume and 11% by volume or less, more than 0% by volume and 10% by volume or less, or more than 0% by volume and 8% by volume or less.

The cemented carbide of Embodiment I may consist of a plurality of tungsten carbide particles, a binder phase, and another phase. To the extent that the effect of the present disclosure is not impaired, the cemented carbide of Embodiment 1 may consist of a plurality of tungsten carbide particles, a binder phase, another phase, and an impurity.

Examples of the impurity include iron (Fe), calcium (Ca), silicon (Si), and sulfur(S). The content of the impurity in the cemented carbide is acceptable to the extent that the effect of the present disclosure is not impaired. For example, the content of the impurity in the cemented carbide may be 0% by mass or more and less than 0.1% by mass. The content of the impurity in the cemented carbide is measured by Inductively Coupled Plasma Emission Spectroscopy (ICP emission spectroscopy) For the measurement device, “ICPS-8100”™ manufactured by SHIMADZU CORPORATION can be used.

The content of the tungsten carbide particles in the cemented carbide of Embodiment I may be 75% by volume or more and 99.5% by volume or less, 80% by volume or more and 99% by volume or less, 85% by volume or more and 99% by volume or less, or 87% by volume or more and 99% by volume or less.

A method for measuring the content (% by volume) of the tungsten carbide particles in the cemented carbide and the content (% by volume) of the binder phase in the cemented carbide is as follows.
(A1) An arbitrary place of the cemented carbide is cut out to expose a cross section. The cross-section is mirror-polished by a cross-sectional polisher (manufactured by JEOL Ltd.).
(B1) The mirror-polished surface of the cemented carbide is analyzed using an energy-dispersive X-ray spectrometer attached to a scanning electron microscope (SEM-EDX) (device: Gemini 450™ manufactured by Carl Zeiss AG) to identify elements contained in the cemented carbide.
(C1) The mirror-polished surface of the cemented carbide is photographed with a scanning electron microscope (SEM) to obtain a reflective electron image. The photographed region is set in the central part of the cross-section of the cemented carbide, that is, a place not including a part that has a nature obviously different from the bulk part such as a part near the surface of the cemented carbide (a place where the whole of the photographed region is the bulk parts of the cemented carbide). The observation magnification is 5000 times. The measurement conditions are an acceleration voltage of 3 kV, a current value of 2 nA, and a working distance (WD) of 5 mm.
(D1) The photographed region of the above (C1) is analyzed using SEM-EDX to identify the distribution of elements identified in the above (B1) in the photographed region, and an element mapping image is obtained.
(E1) The reflective electron image obtained in the above (C1) is captured in a computer, and subjected to binarization using an image analysis software (OpenCV, SciPy). In the image after binarization, the tungsten carbide particles are shown in white and the binder phase is shown in black. It should be noted that the threshold of binarization is set for each image because it changes depending on the contrast.
(F1) The element mapping image obtained in the above (D1) and the image after binarization obtained in the above (E1) are superimposed to identify presence regions of each of the tungsten carbide particles and the binder phase in the image after binarization. Specifically, the region shown in white in the image after binarization and where tungsten (W) and carbon (C) are present in the element mapping image corresponds to a presence region of the tungsten carbide particles. A region shown in black in the image after binarization and where cobalt (Co) is present in the element mapping image corresponds to a presence region of the binder phase.
(G1) In the image after binarization, a measurement field of view of rectangle of 24.9 μm×18.8 μm is set. Using the area of the whole measurement field of view as a denominator, the area percentages of each of the tungsten carbide particles and the binder phase are measured with the above image analysis software.
(H1) The measurements of the above (G1) are performed in five different measurement fields of view that do not overlap each other. In the present disclosure, the average area percentage of the tungsten carbide particles in the five measurement fields of view corresponds to the content (% by volume) of the tungsten carbide particles in the cemented carbide, and the average area percentage of the binder phase in the five measurement fields of view corresponds to the content (% by volume) of the binder phase in the cemented carbide.

When the cemented carbide includes another phase in addition to the WC particles and the binder phase, the content of the another phase in the cemented carbide can be obtained by subtracting the content (% by volume) of the tungsten carbide particles and the content (% by volume) of the binder phase measured by the above procedure from the whole of the cemented carbide (100% by volume).

As long as the measurement is performed on the same sample, it was confirmed that there is little variation in the measurement results even when the content of the tungsten carbide particles and the content of the binder phase in the cemented carbide are measured multiple times according to the above procedure by arbitrary setting the cutout place of the cross section of the cemented carbide, the photographed region described in the above (C1), and the measurement field of view described in the above (G1).

### <Tungsten Carbide Particles>

In the cemented carbide of Embodiment 1, the tungsten carbide particles include at least any of “pure WC particles (including WC that does not contain any impurity elements and WC in which the content of impurity elements is less than the detection limit)” and “WC particles in which impurity elements are intentionally or inevitably contained therein as long as the effect of the present disclosure is not impaired”. The content of the impurity in the tungsten carbide particles (when there are two or more kinds of elements that constitute the impurity, the total concentration of them) is less than 0.1% by mass The content of impurity elements in the tungsten carbide particles is measured by ICP emission spectroscopy.

In Embodiment 1, the average particle size of the tungsten carbide particles is not particularly limited. It has been confirmed that the cemented carbide of Embodiment 1 enables the longer tool life when used as a material for a cutting tool regardless of the average particle size of the tungsten carbide particles. From the viewpoint of improving the tool life, the average particle size of the tungsten carbide particles may be 0.2 μm or more and 3 μm or less, 0.2 μm or more and 2.8 μm or less, or 0.2 μm or more and 2.5 μm or less.

The method for measuring the average particle size of the tungsten carbide particles is as follows. A measurement field of view of rectangle of 24.9 μm×18.8 μm is set in the image after binarization in the same manner as in (A1) to (G1) of the method for measuring the content of the tungsten carbide particles and the content of the binder phase in the cemented carbide. The circle equivalent diameter (Heywood diameter: area equivalent circle diameter) is measured for each of all tungsten carbide particles in the measurement field of view with the image analysis software described above. The above measurement is performed in three different measurement fields of view that do not overlap each other. In the present disclosure, a 50% cumulative particle size (circle equivalent diameter) D50 on area basis is calculated based on all tungsten carbide particles in the three measurement fields of view. The D50 corresponds to the average particle size of the tungsten carbide particles.

As long as the measurement is performed on the same sample, it was confirmed that there is little variation in the measurement results even when the average particle size of tungsten carbide particles is measured multiple times according to the above procedure by arbitrary setting the cutout place of the cross section of the cemented carbide, the photographed region described in the above (C1), and the above measurement field of view.

### <Binder Phase>

### <<Cobalt>>>

In the cemented carbide of Embodiment I, the binder phase comprises 40% by mass or more of cobalt. According to this, the cemented carbide can have excellent toughness. The cobalt content in the binder phase may be 40% by mass or more and less than 100% by mass, 50% by mass or more and 90% by mass or less, or 60% by mass or more and 80% by mass or less.

The method for measuring the cobalt content in the binder phase is as follows. An element mapping image and an image after binarization are obtained in the same manner as in (A1) to (E1) of the above-described method for measuring the content of the tungsten carbide particles and the content of the binder phase in the cemented carbide. The element mapping image and the image after binarization are superimposed to identify a presence region of binder phase in the element mapping image. One measurement field of view of rectangle of 24.9 μm×18.8 μm is set in the image of the element mapping image. The cobalt content is measured in the presence region of the binder phase in the measurement field of view. The above measurement is performed in five different measurement fields of view that do not overlap each other. In the present disclosure, the average cobalt content in the presence region of the binder phase in the five measurement fields of view corresponds to the cobalt content in the binder phase.

As long as the measurement is performed on the same sample, it was confirmed that there is little variation in the measurement results even when the cobalt content in the binder phase is measured multiple times according to the above procedure by arbitrary setting the cutout place of the cross section of the cemented carbide, the photographed region described in the above (C1), and the above measurement field of view.

### <<First Element>>

In the cemented carbide of Embodiment 1, the binder phase further comprises at least one first element selected from the group consisting of silicon, phosphorus, germanium, tin, rhenium, ruthenium, osmium, iridium, and platinum.

The fact that the binder phase comprises the first element is confirmed by the following procedures. An element mapping image and an image after binarization are obtained in the same manner as in (A1) to (E1) of the above-described method for measuring the content of the tungsten carbide particles and the content of the binder phase in the cemented carbide. The element mapping image and the image after binarization are superimposed to identify a presence region of the binder phase in the element mapping image. In the element mapping, when the first element is present in the presence region of the binder phase, it is confirmed that the binder phase comprises the first element.

In the binder phase of the cemented carbide of Embodiment 1, the percentage {M1/(M1+M2)}×100 of mass M1 of the first element with respect to the total M1+M2 of mass M1 of the first element and mass M2 of the cobalt may be 0.2% or more and 25% or less. 2% or more and 5% or less, or 3% or more and 4% or less. Here, the units of mass M1 and mass M2 are the same. The mass M1 of the first element means the total mass of the first elements of all kinds when the binder phase comprises two of more kinds of the first elements.

The method for measuring the above percentage {M1/(M1+M2)}×100 is as follows. An element mapping image and an image after binarization are obtained in the same manner as in (A1) to (B1) of the above-described method for measuring the content of the tungsten carbide particles and the content of the binder phase in the cemented carbide. The element mapping image and the image after binarization are superimposed to identify a presence region of the binder phase in the element mapping image. One measurement field of view of rectangle of 24.9 μm×18.8 μm is set in the image of the element mapping image. In the presence region of the binder phase in the measurement field of view, the percentage {m1/(m1+m2)}×100 of mass m1 of the first element with respect to the total m1+m2 of mass m1 of the first element and mass m2 of cobalt is calculated. The above measurement is performed in five different measurement fields of view that do not overlap each other. In the present disclosure, an average of percentages {m1/(m1+m2)}×100 in the five measurement fields of view corresponds to a “percentage {M1/(M1+M2)}×100” in the binder phase of the cemented carbide.

As long as the measurement is performed on the same sample, it was confirmed that there is little variation in the measurement results even when the percentage {M1/(M1+M2)}×100 is measured multiple times according to the above procedure by arbitrary setting the cutout place of the cross section of the cemented carbide, the photographed region described in the above (C1), and the above measurement field of view.

In the cemented carbide of Embodiment 1, the binder phase may comprise, in addition to cobalt and the first element, at least one second element selected from the group consisting of iron (Fe), nickel (Ni) and chromium (Cr). The binder phase may consist of cobalt, the first element, and the second element. The binder phase may consist of cobalt, the first element, the second element, and an inevitable impurity. Examples of the inevitable impurity include iron (Fe), nickel (Ni) and sulfur(S).

### <<Inconsistency in Atomic Arrangements of Cobalt Atoms>

The frequency of inconsistency in atomic arrangements of cobalt atoms in a rectangular measurement region provided in a TEM-HAADF image obtained by observing a (110) plane having an fee structure of the binder phase of the cemented carbide of Embodiment I at a magnification of 5 million times using an atomic resolution transmission electron microscope, in which the rectangular measurement region contains 31 cobalt atoms in a first direction and 5 or more and 10 or less cobalt atoms in a second direction orthogonal to the first direction, is 8% or more and 30.0% or less. The frequency of inconsistency in atomic arrangements of the cobalt atoms. may be 8.0% or more and 29.2% or less, 8.1% or more and 25.0% or less, or 9,0% or more and 20.0% or less.

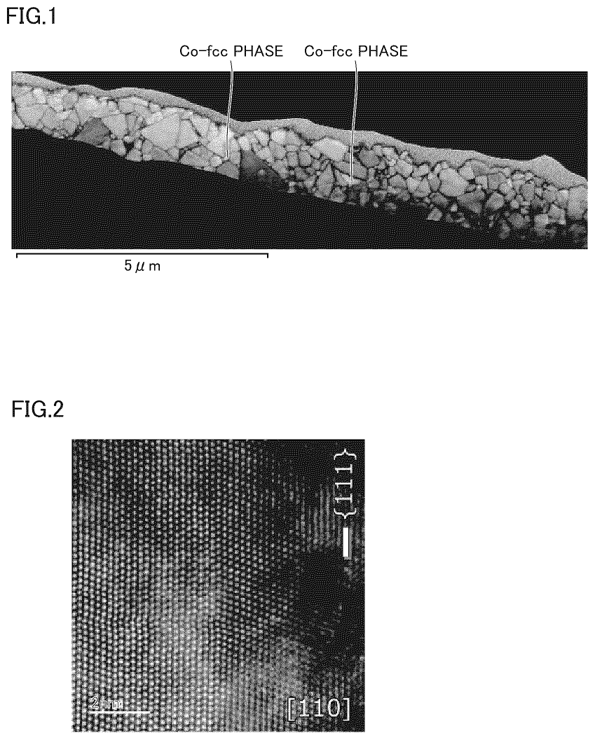

The method for measuring the frequency of inconsistency in atomic arrangements of the cobalt atoms will be described with FIGS. 1 to 3.
(A2) The cemented carbide is sliced to a thickness of 30-100 nm under the conditions of an acceleration voltage of 6 kV and a finishing of 2 EV using an argon ion slicer (“IB-09060CIS Cryo Ton Slicer”™ manufactured by JEOL Ltd.) to prepare a measurement sample

The measurement sample is subjected to EBSD analysis under the following measurement conditions using an electric field emission scanning electron microscope (FE-SEM) (“Gemini 450”™ manufactured by Carl Zeiss AG) equipped with an electron beam backscatter diffraction device (EBSD device).

### <<Measurement Conditions>>

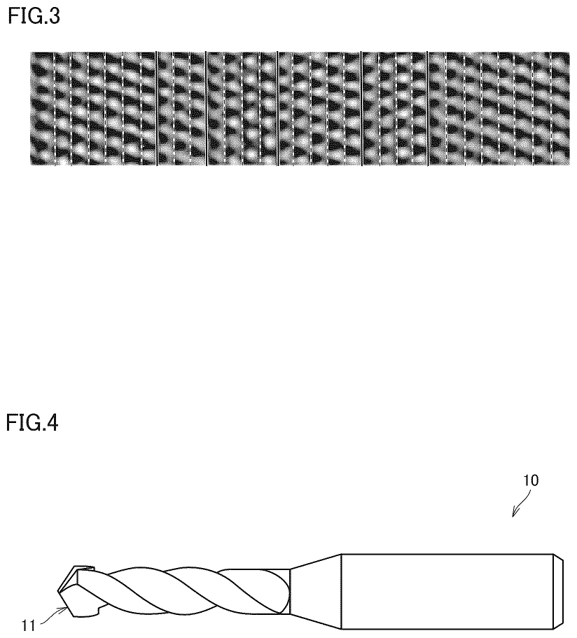

Acceleration voltage: 30 kV
Shooting magnification: 10000 times
Current value: 22 nA
WD: 4 mm
Tilt: 20°
Step size: 0.02 μm
(B2) The EBSD analysis results are analyzed using a crystal orientation analyzer (analysis software “AZtecCrystal Version 3.1” manufactured by Oxford Instruments) to create an Inverse Pole Figure map (IPF map) of the analysis regions. In the creation of the IPF map, when the azimuth difference angle of adjacent measurement points is 15° or more, it is defined as the grain boundary. In the IPF map, the crystal orientation of each crystal grain is indicated by color coding. FIG. 1 is an example of an IPF map of the cemented carbide of Embodiment 1.
(C2) On the IPF map, cobalt having an fcc structure is identified. In FIG. 1, an example of cobalt having an fcc structure is shown as a Co-fcc phase. In general, the main crystal structure of cobalt in cemented carbides is an fcc structure. For example, in the cemented carbide of Embodiment 1, more than 50% by volume of cobalt may be an fcc structure, or 60% by volume or more of cobalt may be an fcc structure. In the cemented carbide of Embodiment 1, it has been confirmed that as long as more than 50% by volume of cobalt is an fcc structure and the frequency of inconsistency in atomic arrangements of cobalt atoms is 8% or more, the effect of the present disclosure derived from the frequency of inconsistency in atomic arrangements of the cobalt atoms can be obtained.
(D2) The (110) plane of the cobalt having the fcc structure identified on the IPF map is observed at a magnification of 5 million times using an atomic resolution transmission electron microscope (“JEM-ARM300F2”™ manufactured by JEOL Ltd.) to obtain a TEM-HAADF image. FIG. 2 is an example of a TEM-HAADF image of the cemented carbide of Embodiment 1.
(E2) A rectangular measurement region containing 31 cobalt atoms in a first direction and 5 or more and 10 or less cobalt atoms in a second direction orthogonal to the first direction is provided in the TEM-HAADF image. FIG. 3 is an example showing extraction of the measurement region set in the TEM-HAADF image of FIG. 2. In FIG. 3, the boundaries between the atomic arrangements of the cobalt atoms are shown with dotted and solid lines. In FIG. 3, the solid line shows a boundary between the atomic arrangements in which adjacent atomic arrangements of the cobalt atoms are inconsistent. The boundary between the atomic arrangements in which adjacent atomic arrangements of the cobalt atoms are inconsistent corresponds to the boundary between an fcc structure and an hep structure of cobalt observed in the TEM-HAADF image. In the cemented carbide of Embodiment 1, when cobalt having the fcc structure identified on the IPF map is observed at a magnification of 5 million times in the TEM-HAADF image, the fcc structure and the hop structure are present.

In the measurement region set in the TEM-HAADF image, the total number of boundaries between the atomic arrangements of the cobalt atoms (the total number of the boundaries is 30), and the number of boundaries between the atomic arrangements in which adjacent atomic arrangements of the cobalt atoms are inconsistent are counted. Here, the boundary between the atomic arrangements of the cobalt atoms is a boundary that extends in the direction along the second direction. The percentage of the number of boundaries between the atomic arrangements in which adjacent atomic arrangements of the cobalt atoms are inconsistent, with respect to the total number of boundaries between the atomic arrangements of the cobalt atoms is calculated. The percentage corresponds to the frequency of inconsistency in atomic arrangements of the cobalt atoms. For example, in the TEM-HAADF image of FIG. 3, the total number of boundaries between the atomic arrangements of the cobalt atoms is 30, and the number of boundaries between the atomic arrangements in which adjacent atomic arrangements of the cobalt atoms are inconsistent is 5, and the percentage of the number of boundaries between the atomic arrangements in which adjacent atomic arrangements of the cobalt atoms are inconsistent, with respect to the total number of boundaries between the atomic arrangements of the cobalt atoms is 16.7%.

In the present disclosure, when the measurement of (E2) is performed in three different measurement regions that do not overlap each other, and the frequency of inconsistency in the atomic arrangements of the cobalt atoms in the two or more measurement regions is 8% or more, the frequency of inconsistency in the atomic arrangements of the cobalt atoms in the measurement region of the cemented carbide is determined to be 8% or more. Other frequencies (e g., 10% or more) of inconsistency in atomic arrangements of the cobalt atoms are also determined by whether two or more measurement regions of three measurement regions satisfy the frequency.

As long as the measurement is performed on the same sample, it was confirmed that there is little variation in the measurement results even when the cutout place of the cross section of the cemented carbide, the places for creating the IPF map and the TEM-HAADF image, and the measurement region described in the above (E2) are arbitrarily set.

### <Method for Producing Cemented Carbide>

The cemented carbide of Embodiment 1 can be produced by performing a preparation step of raw material powders, a mixing step, a molding step, a sintering step, and a cooling step in the order described above. Each step will be described below.

### <Preparation Step>

The preparation step is a step of preparing the raw material powders of the cemented carbide. Examples of the raw material powders include a tungsten carbide powder (hereinafter also referred to as “WC powder”), a cobalt powder, a first element powder, and an alloy powder of the first element and cobalt. Examples of the first element powder include a silicon powder, a phosphorus powder, a germanium powder, a tin powder, a rhenium powder, a ruthenium powder, an osmium powder, an iridium powder, and a platinum powder.

As the raw material powders, a nickel powder, a vanadium carbide powder, a titanium carbonitride powder, and the like can be further prepared. These raw material powders can be commercially available.

The average particle size of the raw material powders is not particularly limited, and may be, for example, 0.5 to 5 μm. The average particle size of the raw material powder means an average particle size measured by the Fisher Sub-Sieve Sizer (FSSS) method. The average particle size is measured using “Sub-Sieve Sizer Model 9S”™ manufactured by Thermo Fisher Scientific, Inc.

### <Mixing Step>

The mixing step is a step of mixing each raw material powder prepared in the preparation step in a predetermined ratio. A mixed powder in which each raw material powder is mixed is obtained by the mixing step. The mixing ratio of each raw material powder is appropriately adjusted according to the composition of the cemented carbide to be targeted.

An attritor is used for mixing each raw material powder. First, the raw material powders of the binder phase (a cobalt powder, a first element powder, an alloy powder of the first element and cobalt, a nickel powder) are charged to the attritor, and the powders are strongly crushed (conditions: 300 rpm for 2 hours). The other raw material powders are then charged to the attritor and mixed (conditions: 200 rpm for 6 hours).

After the mixing step, the mixed powder may be granulated as needed. By granulating the mixed powder, it is easy to fill a die or mold with the mixed powder during the molding step described below. For granulation, known granulation methods can be applied, and for example, commercial granulators such as spray dryers can be used.

### <Molding Step>

The molding step is a step of molding the mixed powder obtained in the mixing step into a shape for a cutting tool to obtain a molded body. The molding method and molding conditions in the molding step are not particularly limited, and general methods and conditions can be applied.

### <Sintering Step>

The sintering step is a step of sintering the molded body obtained in the molding step to obtain a cemented carbide intermediate. The sintering conditions are holding the molded body in an Ar atmosphere at 1350° C., 7 MPa for 2 hours.

### <Cooling Step>

The cooling step is a step of cooling the cemented carbide intermediate after the sintering step to obtain a cemented carbide. Specifically, the cemented carbide intermediate is cooled at −50° C./min.

### Embodiment 2: Cutting Tool

A cutting tool of an embodiment of the present disclosure (hereinafter also referred to as “Embodiment 2”) is a cutting tool comprising a cutting edge consisting of the cemented carbide of Embodiment 1. In the present disclosure, a cutting edge means a part that is involved in cutting. More specifically, the cutting edge refers to a region surrounded by a cutting edge ridgeline and a virtual face having a distance of 0.5 mm of 2 mm from the cutting edge ridgeline to the cemented carbide side.

Examples of the cutting tool include a cutting byte, a drill, an end mill, an indexable cutting insert for milling, an Indexable cutting insert for turning, a metal saw, a gear cutting tool, a reamer, and a tap. In particular, as shown in FIG. 4, a cutting tool 10 of Embodiment 2 can exert an excellent effect when it is a small diameter drill for printed circuit board processing. A cutting edge 11 of cutting tool 10 shown in FIG. 4 consists of the cemented carbide of Embodiment 1.

In the cutting tool of Embodiment 2, the cemented carbide of Embodiment 1 may constitute the whole or a part of the tool. Here, the terms “constitute a part” refers to an aspect in which the cemented carbide of Embodiment 1 is brazed to a predetermined position of any substrate to serve as a cutting edge part, or the like.

The cutting tool of Embodiment 2 may further comprise a hard film covering at least a portion of the surface of a substrate consisting of the cemented carbide. As the hard film, diamond-like carbon, diamond, or the like can be used.

### EXAMPLES

The present embodiments will be described in more detail by way of Examples. However, the present embodiments are not limited by these Examples.

### [Production of Cemented Carbide]

A cemented carbide of each sample was produced by the following procedure.

### <Preparation Step>

As the raw material powders, a WC powder (average particle size: as described in Table 1), a Co powder (average particle size: 1 μm), a first element powder, an Ni powder (average particle size: 1 μm), a VC powder (average particle size: 1 μm), and a TiCN powder (average particle size: 1 μm) were prepared. As the first element powders, a silicon (St) powder (average particle size. 1 μm), a phosphorus (P) powder (average particle size: 1 μm), a germanium (Ge) powder (average particle size: 1 μm), a tin (Sn) powder (average particle size: 1 μm), a rhenium (Re) powder (average particle size: 1 μm), a ruthenium (Ru) powder (average particle size: 1 μm), an osmium (Os) powder (average particle size: 1 μm), an iridium (Ir) powder (average particle size: | μm), and a platinum (Pt) powder (average particle size: 1 μm) were prepared. Each raw material powder was prepared in the ratio described in Table 1. The ratio (% by mass) of each raw material powder described in Table 1 is the ratio when the total of the raw material powders is set to 100% by mass. The term “remaining” in the “% by mass” column of “WC powder” means the value obtained by subtracting the ratio of the raw material powders other than the WC powder from the total 100% by mass of the raw material powders.

TABLE 1

| | Raw material powder | | | | | | |
|---|---|---|---|---|---|---|---|
| | WC powder | | | | | | |
| | Average | | Co | | | First | |
| | particle | | powder | Others | | element powder | |
| Sample | size | % by | % by | | % by | | % by |
| No. | μm | mass | mass | Kind | mass | Kind | mass |
| 1 | 0.8 | remaining | 6.0 | VC | 0.10 | Ge | 0.10 |
| 2 | 0.8 | remaining | 6.0 | — | — | Ge | 0.10 |
| 3 | 0.8 | remaining | 2.4 | Ni | 3.60 | Ge | 0.10 |
| 4 | 0.8 | remaining | 0.3 | VC | 0.05 | Ge | 0.01 |
| 5 | 0.8 | remaining | 15.0 | VC | 0.10 | Ge | 0.50 |
| 6 | 0.8 | remaining | 6.0 | TiCN | 4.00 | Ge | 0.10 |
| 7 | 0.2 | remaining | 6.0 | VC | 0.10 | Ge | 0.10 |
| 8 | 3.0 | remaining | 6.0 | — | — | Ge | 0.10 |
| 9 | 0.8 | remaining | 6.0 | VC | 0.10 | Ge | 0.01 |
| 10 | 0.8 | remaining | 6.0 | VC | 0.10 | Ru | 2.00 |
| 11 | 0.8 | remaining | 6.0 | VC | 0.10 | Si | 2.00 |
| 12 | 0.8 | remaining | 6.0 | VC | 0.10 | Si | 1.50 |
| 13 | 0.8 | remaining | 6.0 | VC | 0.10 | Si | 1.00 |
| 14 | 0.8 | remaining | 6.0 | VC | 0.10 | Si | 0.15 |
| 15 | 0.8 | remaining | 6.0 | VC | 0.10 | P | 0.05 |
| 16 | 0.8 | remaining | 6.0 | VC | 0.10 | Sn | 0.05 |
| 17 | 0.8 | remaining | 6.0 | VC | 0.10 | Re | 0.50 |
| 18 | 0.8 | remaining | 6.0 | VC | 0.10 | Ru | 1.00 |
| 19 | 0.8 | remaining | 6.0 | VC | 0.10 | Os | 0.05 |
| 20 | 0.8 | remaining | 6.0 | VC | 0.10 | Ir | 0.05 |
| 21 | 0.8 | remaining | 6.0 | VC | 0.10 | Pt | 0.05 |
| 1-1 | 0.8 | remaining | 6.0 | VC | 0.10 | — | 0.00 |
| 1-2 | 0.8 | remaining | 0.2 | VC | 0.10 | Ge | 0.01 |
| 1-3 | 0.8 | remaining | 15.5 | VC | 0.10 | Ge | 0.50 |
| 1-4 | 0.8 | remaining | 6.0 | TiCN | 4.50 | Ge | 0.10 |
| 1-5 | 0.8 | remaining | 2.2 | Ni | 3.80 | Ge | 0.10 |
| 1-6 | 0.8 | remaining | 6.0 | VC | 0.10 | Ge | 0.10 |
| 1-7 | 0.8 | remaining | 6.0 | VC | 0.10 | Si | 2.20 |

### <Mixing Step>

In the samples for which “strong crushing->mixing” is described in the “mixing” column of Table 2, the mixing was performed by the following procedure. First, the raw material powders of the binder phase (the cobalt powder, the first element powder) were charged to an attritor, and the powders were strongly crushed (conditions: 300 rpm for 2 hours). The other raw material powders were then charged to the attritor and mixed (conditions: 200 rpm for 6 hours).

In the samples for which “normal mixing” is described in the “mixing” column of Table 2, all the raw material powders were charged to an attritor at the same time and mixed for 10 hours:

### <Molding Step>

The mixed powder was pressed to obtain a molded body having a round bar shape or an insert shape (CNMG120408N-GU).

### <Sintering Step>

The molded body was sintered under the conditions described in the “sintering” column of Table 2 in an Ar atmosphere to obtain a cemented carbide intermediate.

### <Cooling Step>

The cemented carbide intermediate was cooled at the cooling rate described in the “cooling” column of Table 2 to obtain a cemented carbide.

TABLE 2

| | | Sintering | | | Cooling: |
|---|---|---|---|---|---|
| Sample | | Temperature | Pressure | Time | Cooling rate |
| No. | Mixing | ° C. | MPa | hr | ° C./min |
| 1 | strong crushing → mixing | 1350 | Ar-7 MPa | 2 | −50 |
| 2 | strong crushing → mixing | 1350 | Ar-7 MPa | 2 | −50 |
| 3 | strong crushing → mixing | 1350 | Ar-7 MPa | 2 | −50 |
| 4 | strong crushing → mixing | 1350 | Ar-7 MPa | 2 | −50 |
| 5 | strong crushing → mixing | 1350 | Ar-7 MPa | 2 | −50 |
| 6 | strong crushing → mixing | 1350 | Ar-7 MPa | 2 | −50 |
| 7 | strong crushing → mixing | 1350 | Ar-7 MPa | 2 | −50 |
| 8 | strong crushing → mixing | 1350 | Ar-7 MPa | 2 | −50 |
| 9 | strong crushing → mixing | 1350 | Ar-7 MPa | 2 | −50 |
| 10 | strong crushing → mixing | 1350 | Ar-7 MPa | 2 | −50 |
| 11 | strong crushing → mixing | 1350 | Ar-7 MPa | 2 | −50 |
| 12 | strong crushing → mixing | 1350 | Ar-7 MPa | 2 | −50 |
| 13 | strong crushing → mixing | 1350 | Ar-7 MPa | 2 | −50 |
| 14 | strong crushing → mixing | 1350 | Ar-7 MPa | 2 | −50 |
| 15 | strong crushing → mixing | 1350 | Ar-7 MPa | 2 | −50 |
| 16 | strong crushing → mixing | 1350 | Ar-7 MPa | 2 | −50 |
| 12 | strong crushing → mixing | 1350 | Ar-7 MPa | 2 | −50 |
| 18 | strong crushing → mixing | 1350 | Ar-7 MPa | 2 | −50 |
| 19 | strong crushing → mixing | 1350 | Ar-7 MPa | 2 | −50 |
| 20 | strong crushing → mixing | 1350 | Ar-7 MPa | 2 | −50 |
| 21 | strong crushing → mixing | 1350 | Ar-7 MPa | 2 | −50 |
| 1-1 | strong crushing → mixing | 1350 | Ar-7 MPa | 2 | −50 |
| 1-2 | strong crushing → mixing | 1350 | Ar-7 MPa | 2 | −50 |
| 1-3 | strong crushing → mixing | 1350 | Ar-7 MPa | 2 | −50 |
| 1-4 | strong crushing → mixing | 1350 | Ar-7 MPa | 2 | −50 |
| 1-5 | strong crushing → mixing | 1350 | Ar-7 MPa | 2 | −50 |
| 1-6 | normal mixing | 1380 | Ar-7 kPa | 1 | −10 |
| 1-7 | normal mixing | 1350 | Ar-7 MPa | 2 | −50 |

### [Evaluation of Cemented Carbide]

### <Content (% by Volume) of Tungsten Carbide Particles and Content (% by Volume) of Binder Phase in Cemented Carbide>

The content (% by volume) of the tungsten carbide particles and the content (% by volume) of the binder phase in the cemented carbide of each sample were measured by the method described in Embodiment 1. The results are shown in Table 3. In addition, the total of the content of the tungsten carbide particles and the content of the binder phase (content of WC particles+binder phase) in the cemented carbide is shown in Table 3. It was confirmed that the cemented carbide with less than 100% by volume in the “content of WC particles+binder phase” column contained TION or VC.

### <Cobalt Content in Binder Phase>

In the cemented carbide of each sample, the cobalt content in the binder phase was measured by the method described in Embodiment 1. The results are shown in Table 3.

### <Kind of First Element, and {M1/(M1+M2)}×100>

In the binder phase of the cemented carbide of each sample, the kind and content of the first element, and the percentage {M1/(M)+M2)}×100 of mass M1 of the first element with respect to the total M1+M2 of mass M1 of the first element and mass M2 of cobalt were measured by the method described in Embodiment 1. The results are shown in Table 3. A sample described as “-” in the “first element” column indicates that it does not contain a first element.

### [Average Particle Size of Tungsten Carbide Particles]

In the cemented carbide of each sample, the average particle size of the tungsten carbide particles was measured by the method described in Embodiment 1. The 26 results are shown in Table 3.

### <Inconsistency in Atomic Arrangements of Cobalt Atoms>>

In the cemented carbide of each sample, the frequency of inconsistency in atomic arrangements of the cobalt atoms was measured by the method described in Embodiment 1. Of the frequencies of inconsistency in atomic arrangements of the cobalt atoms measured in pack of the three measurement regions the second smallest value is mona in Table 3. Table 3 shows the value of B when the three frequencies A, B and C satisfy A=B<C, the value of B when A=B=C, and the value of B when A<B=C. It was confirmed that more than 50% by volume of cobalt had an fcc structure in all samples.

TABLE 3

| | Cemented carbide | | | | | | | | |
|---|---|---|---|---|---|---|---|---|---|
| | | | | WC | Binder phase | | | | |
| | | | | particles + | | | | | Inconsistency |
| | WC particles | | Binder | binder | | First | | M1/ | in atomic |
| | Average | | phase | phase | Co | element | | (M1 + | arrangements |
| | particle | Content | Content | Content | content | | Content | M2) × | of Co |
| Sample | size | % by | % by | % by | % by | | % by | 100 | atoms |
| No. | μm | volume | volume | volume | mass | Kind | mass | % | % |
| 1 | 0.8 | 88.7 | 10.3 | 99.0 | 99 | Ge | 0.10 | 1.6 | 8.5 |
| 2 | 0.8 | 89.7 | 10.3 | 100 | 99 | Ge | 0.10 | 1.6 | 9.8 |
| 3 | 0.8 | 89.7 | 10.3 | 100 | 40 | Ge | 0.10 | 1.6 | 9.2 |
| 4 | 0.8 | 99.0 | 0.5 | 99.5 | 99 | Ge | 0.01 | 3.2 | 8.2 |
| 5 | 0.8 | 74.2 | 24.6 | 99.0 | 99 | Ge | 0.50 | 3.2 | 9.9 |
| 6 | 0.8 | 79.4 | 9.6 | 89.0 | 99 | Ge | 0.10 | 1.6 | 8.4 |
| 7 | 0.2 | 88.7 | 10.3 | 99.0 | 99 | Ge | 0.10 | 1.6 | 8.4 |
| 8 | 2.8 | 89.7 | 10.3 | 100 | 99 | Ge | 0.10 | 1.6 | 9.7 |
| 9 | 0.8 | 89.0 | 10.0 | 99.0 | 99 | Ge | 0.01 | 0.2 | 8.1 |
| 10 | 0.8 | 86.6 | 12.4 | 99.0 | 99 | Ru | 2.00 | 25.0 | 10.3 |
| 11 | 0.8 | 78.3 | 20.7 | 99.0 | 99 | Si | 2.00 | 25.0 | 29.2 |
| 12 | 0.8 | 80.8 | 18.2 | 99.0 | 99 | Si | 2.00 | 20.0 | 24.0 |
| 13 | 0.8 | 83.5 | 15.5 | 99.0 | 99 | Si | 2.00 | 14.3 | 18.9 |
| 14 | 0.8 | 88.1 | 10.9 | 99.0 | 99 | Si | 0.15 | 2.4 | 9.7 |
| 15 | 0.8 | 87.9 | 11.1 | 99.0 | 99 | P | 0.05 | 0.8 | 9.0 |
| 16 | 0.8 | 88.7 | 10.3 | 99.0 | 99 | Sn | 0.05 | 0.8 | 6.8 |
| 17 | 0.8 | 88.6 | 10.4 | 99.0 | 99 | Re | 0.50 | 7.7 | 9.5 |
| 18 | 0.8 | 87.8 | 11.2 | 99.0 | 99 | Ru | 1.00 | 14.3 | 9.6 |
| 19 | 0.8 | 89.0 | 10.0 | 99.0 | 99 | Os | 0.05 | 0.8 | 9.4 |
| 20 | 0.8 | 89.0 | 10.0 | 99.0 | 99 | Ir | 0.05 | 0.8 | 9.1 |
| 21 | 0.8 | 89.0 | 10.0 | 99.0 | 99 | Pt | 0.05 | 0.8 | 8.7 |
| 1-1 | 0.8 | 89.0 | 10.0 | 99.0 | 99 | — | 0.00 | 0.0 | 4.5 |
| 1-2 | 0.8 | 98.6 | 0.4 | 99.0 | 99 | Ge | 0.01 | 4.8 | 8.1 |
| 1-3 | 0.8 | 73.6 | 25.4 | 99.0 | 99 | Ge | 0.50 | 3.1 | 8.1 |
| 1-4 | 0.8 | 77.5 | 9.5 | 87.0 | 99 | Ge | 0.10 | 1.6 | 8.2 |
| 1-5 | 0.8 | 89.7 | 10.3 | 100 | 37 | Ge | 0.10 | 4.3 | 8.0 |
| 1-6 | 0.8 | 88.7 | 10.3 | 99.0 | 99 | Ge | 0.10 | 1.6 | 5.5 |
| 1-7 | 0.8 | 78.3 | 20.7 | 99.0 | 99 | Si | 2.00 | 26.8 | 30.3 |

### [Cutting Test 1]

Round bars consisting of cemented carbide of each sample were processed to produce a drill for printed circuit board processing (Printed Circuit Board (PCB) drill) with a blade diameter of φ0.18 mm. The fracture rate was evaluated by drilling a commercially available printed circuit board for semiconductor packaging using the PCB drill. First, two printed circuit boards having a thickness 0.8 mm were stacked, and were drilled using a PCB drill for 10000 hits at a rotational speed of 250 krpm. Then, three printed circuit boards having a thickness of 0.8 mm were stacked, and were drilled using the same PCB drill for 10000 hits at a rotational speed of 250 krpm. The above drilling was performed with 10 PCB drills and the fracture rate was calculated. The lower fracture rate shows the more excellent fatigue fracture resistance of the cutting tool and the longer tool life. The results are shown in Table 4.

### [Cutting Test 2]

On the surface of the cemented carbide having an insert shape (CNMG120408N-GU) of each sample, a TiCN layer having a thickness of 8 μm and an Al₂O₃ layer having a thickness of 8 μm were deposited by CVD in the order above to obtain a surface-coated cutting tool. An end-face processing of a notched round bar made of SCM 435 was performed with a surface-coated cutting to ol of each sample, and the time until the cutting edge chipping occurred was evaluated. The processing conditions were the cutting speed of vc250 m/min, the feed of f0.3 mm/rev, and the cutting amount of ap1.5 mm. The longer time until the cutting edge chipping occurred shows the more excellent breakage resistance of the cutting tool and the longer tool life. The results are shown in Table 4.

TABLE 4

| | Cutting test 1 | Cutting test 2 | |
|---|---|---|---|
| Sample | PCB drill | Insert | |
| No. | Fracture Rate | Life | |
| 1 | 10% | 15 | min |
| 2 | 0% | 17 | min |
| 3 | 10% | 15 | min |
| 4 | 20% | 18 | min |
| 5 | 0% | 20 | min |
| 6 | 10% | 15 | min |
| 7 | 10% | 15 | min |
| 8 | 0% | 30 | min |
| 9 | 20% | 15 | min |
| 10 | 0% | 33 | min |
| 11 | 0% | 38 | min |
| 12 | 0% | 36 | min |
| 13 | 0% | 34 | min |
| 14 | 0% | 17 | min |
| 15 | 10% | 15 | min |
| 16 | 10% | 15 | min |
| 17 | 10% | 18 | min |
| 18 | 10% | 18 | min |
| 19 | 10% | 15 | min |
| 20 | 10% | 15 | min |
| 21 | 10% | 15 | min |
| 1-1 | 80% | 7 | min |
| 1-2 | 90% | 6 | min |
| 1-3 | 100% | 9 | min |
| 1-4 | 80% | 7 | min |
| 1-5 | 80% | 7 | min |
| 1-6 | 80% | 7 | min |
| 1-7 | 70% | 9 | min |

### [Discussion]

The cemented carbides and cutting tools of samples 1 to 21 correspond to Examples. The cemented carbides and cutting tools of samples 1-1 to 1-7 correspond to Examples. It was confirmed that the cutting tools of samples 1 to 21 had a longer tool life in drilling of a printed circuit board and end-face processing of a notched round bar made of SCM 435 compared to the cutting tools of samples 1-1 to 1-7.

Although embodiments and examples of the present disclosure have been described as shown above, it is intended from the beginning that the configurations of each embodiment and example above are appropriately combined or variously modified.

The embodiments and examples of the present disclosure are exemplary in all respects and should not be considered as limiting. The scope of the present invention is indicated by claims, not by the above-described embodiments and examples, and is intended to include all equivalents to the claims and all changes within the scope of the claims.

### REFERENCE SIGNS LIST

10 Cutting tool: 11 Cutting edge

1. A cemented carbide comprising a plurality of tungsten carbide particles and a binder phase, wherein
the cemented carbide comprises 89% by volume or more and 100% by volume or less of the tungsten carbide particles and the binder phase in total,
the cemented carbide comprises 0.5% by volume or more and 25% by volume or less of the binder phase,
the binder phase comprises 40% by mass or more of cobalt,
the binder phase further comprises at least one first element selected from the group consisting of silicon, phosphorus, germanium, tin, rhenium, ruthenium, osmium, iridium, and platinum, and
a frequency of inconsistency in atomic arrangements of cobalt atoms in a rectangular measurement region provided in a TEM-HAADF image obtained by observing a (110) plane of the cobalt having an fcc structure at a magnification of 5 million times using an atomic resolution transmission electron microscope, in which the rectangular measurement region contains 31 cobalt atoms in a first direction and 5 or more and 10 or less cobalt atoms in a second direction orthogonal to the first direction, is 8% or more and 30.0% or less.

2. The cemented carbide according to claim 1, wherein the frequency of inconsistency in atomic arrangements of the cobalt atoms is 10% or more.

3. The cemented carbide according to claim 1, wherein, in the binder phase, a percentage {M1/(M1+M2)}×100 of a mass M1 of the first element with respect to a total M1+M2 of mass M1 of the first element and a mass M2 of the cobalt is 0.2% or more and 25% or less.

4. The cemented carbide according to claim 1, wherein an average particle size of the tungsten carbide particles is 0.2 μm or more and 3 μm or less.

5. The cemented carbide according to claim 1, wherein the frequency of inconsistency in atomic arrangements of the cobalt atoms is a percentage of the number of boundaries between the atomic arrangements in which adjacent atomic arrangements of the cobalt atoms are inconsistent, with respect to a total number of boundaries between the atomic arrangements of the cobalt atoms in the measurement region.

6. A cutting tool comprising a cutting edge consisting of the cemented carbide according to claim 1.
